(19) United States
(12) Patent Application Publication
(10) Pub. No.: US 2011/0219266 A1
(43) Pub. Date: Sep. 8, 2011

(54) System and Method of Testing an Error Correction Module

(75) Inventors: Hari M. Rao, San Diego, CA (US); Shahzad Nazar, San Diego, CA (US); Venugopal Boynapalli, San Diego, CA (US)

(73) Assignee: QUALCOMM Incorporated, San Diego, CA (US)

(21) Appl. No.: 12/717,165

(22) Filed: Mar. 4, 2010

(51) Int. Cl. G06F 11/30; G06F 11/263

(52) U.S. Cl. 714/35; 714/25; 714/E11.177; 714/E11.179

(57) ABSTRACT

In an embodiment, a method of testing an error correction scheme includes selectively observing and controlling data at one or more intermediate test points within an error correction circuit. Erroneous data may be selectively injected at a first intermediate test point and data related to the erroneous data may be observed at a second intermediate test point.

### I. FIELD

The present disclosure is generally related to a system and method of testing memory.

### II. DESCRIPTION OF RELATED ART

Advances in electronic device technology have resulted in smaller device features and lower supply voltages to reduce the power consumption and extend battery life. One result of this trend is that an amount of charge called “critical charge” required to indicate a unit of data, such as a data bit stored at a memory, has become more susceptible to corruption due to noise, and may actually change to the opposite state. For memory subsystems, this is unacceptable as every memory cell is required to retain its data for proper functionality.

Various schemes have been implemented to detect, correct, and otherwise reduce the impact of such data errors. For example, an error correction coding (ECC) scheme processes data (to be written to the memory) using multiple exclusive-OR (XOR) trees to generate check bits that indicate the parity of the received data. The check bits are used with XOR trees to generate syndrome bits indicative of errors detected in the data. The detected errors are then corrected to restore the original data. However, such an error correction scheme may itself be subject to physical defects during manufacturing and malfunction.

### III. SUMMARY

In a particular embodiment, a system is disclosed that includes an error correction coding (ECC) module including an input to receive data and an output to provide error corrected data. The ECC module includes a plurality of intermediate test ports. The ECC module also includes ECC functionality testing logic coupled to the plurality of intermediate test ports.

In another particular embodiment, a method of testing an error correction circuit device is disclosed. The method includes selectively injecting data at an intermediate test point of an error correction coding (ECC) module having multiple intermediate test points. The method also includes observing data related to the injected data at one or more of the multiple intermediate test points.

In another particular embodiment, a method of testing an error correction scheme is disclosed. The method includes selectively observing data at one or more intermediate test points within an error correction circuit.

One particular advantage provided by the disclosed embodiments is that performance of an error correction module may be tested at intermediate processing points within the module. Proper performance of an error correction module may be determined by observing data at the intermediate processing points. Data accuracy of an error correction circuit may be improved by selectively bypassing one or more malfunctioning sub-modules of the error correction circuit.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative embodiment of a system to test an error correction module;

FIG. 2 is a diagram of a second illustrative embodiment of a system to test an error correction module;

FIG. 3 is a circuit diagram of a particular illustrative embodiment of a component of an intermediate test port;

FIG. 4 is a flow chart of a particular illustrative embodiment of a method of testing an error correction circuit device;

FIG. 5 is a flow chart of a particular illustrative embodiment of a method of testing an error correction module; and

FIG. 6 is a block diagram of a communication device that includes a system to test an error correction module.

### V. DETAILED DESCRIPTION

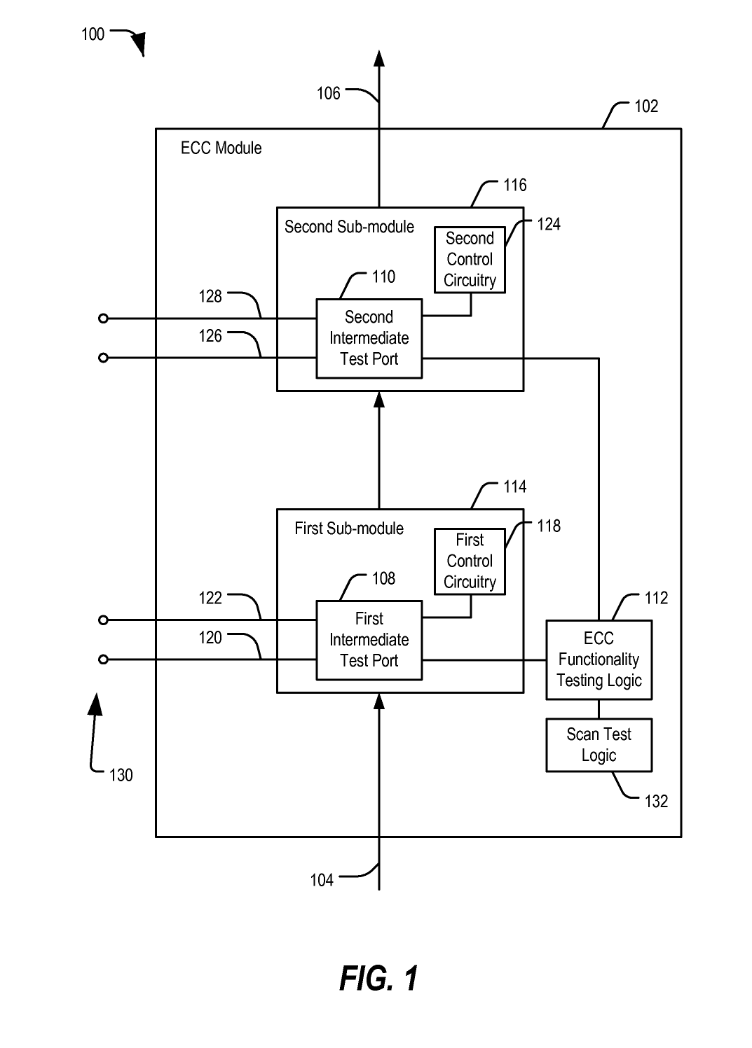

Referring to FIG. 1, a particular illustrative embodiment of a system to test an error correction module is depicted and generally designated 100. The system 100 includes an error correction coding (ECC) module 102. The ECC module 102 includes an input 104 and an output 106. The ECC 102 module also includes intermediate test ports including a first intermediate test port 108 and a second intermediate test port 110. ECC functionality testing logic 112 is coupled to the first intermediate test port 108 and to the second intermediate test port 110. Scan test logic 132 is coupled to each of the intermediate test ports 108 and 110 via the ECC testing logic 112. The ECC module 102 has a first sub-module 114 that includes the first intermediate test port 108 and a second sub-module 116 that includes the second intermediate test port 110.

The first sub-module 114 includes first control circuitry 118 to selectively enable or disable the intermediate test port 108. The first sub-module 114 also includes an input 120 to inject data to the first intermediate test port 108 and an output 122 to provide observable data from the first intermediate test port 108. The second sub-module 116 includes second control circuitry 124 to selectively enable or disable the second intermediate test port 110. The second sub-module 116 also includes an input 126 to inject data to the second intermediate test port 110 and an output 128 to provide observable data from the second intermediate test port 110. The ECC module 102 also includes multiple external pins 130 to provide external access to the intermediate test ports 108 and 110.

The ECC module 102 may be configured to receive data at the input 104 and to process the data, test the data for errors, and provide corrected data at the output 106. For example, the first sub-module 114 may include data encoding circuitry, such as an exclusive-OR (XOR) tree to generate check bits corresponding to received data, and the second sub-module 116 may include data decoding circuitry, such as an XOR tree to generate syndrome bits.

During operation, data is received at the input 104 and processed at the first sub-module 114. Data output at the first sub-module 114 is processed by the second sub-module 116 and a result is provided at the output 106. An operation of the ECC module 102 and the sub-modules 114 and 116 may be observed via the intermediate test ports 108 and 110.

For example, the first intermediate test port 108 enables a user to inspect a state of data processing at the first sub-module 114 via the output 122. The first intermediate test port 108 also enables a user to input test data to the first sub-module 114 via the input 120 and may also enable the user to observe an output of the first sub-module 114 in response to receipt of the test data. Similarly, the second intermediate test port 110 enables a user to inspect a state of data processing at the second sub-module 116 via the output 128. Test data may be injected to the second intermediate test port 110 via the input 126 to test an operation of the second sub-module 116. Data observation and test data injection at the intermediate test ports 108 and 110 may be controlled by the control circuitry 118 and 124, which in turn may be responsive to user control inputs (not shown). The scan test logic 132 may be adapted to selectively apply scan tests at each of the intermediate test ports 108 and 110. In addition, tests of the ECC module 102 may be performed independently from use of the scan test logic 132.

In this manner, one or more stages of an ECC process, such as a process preformed by the ECC module 102, may be observed and tested in individual stages of processing, such as at a first processing stage associated with the first sub-module 114 and a second processing stage associated with the second sub-module 116. Errors occurring at the ECC module 102 may be detected and localized to a sub-module 114 or 116, and a cause or condition of the detected errors may be determined and potentially corrected by use of remedial actions, including bypassing one or more of the sub-modules 114 and 116.

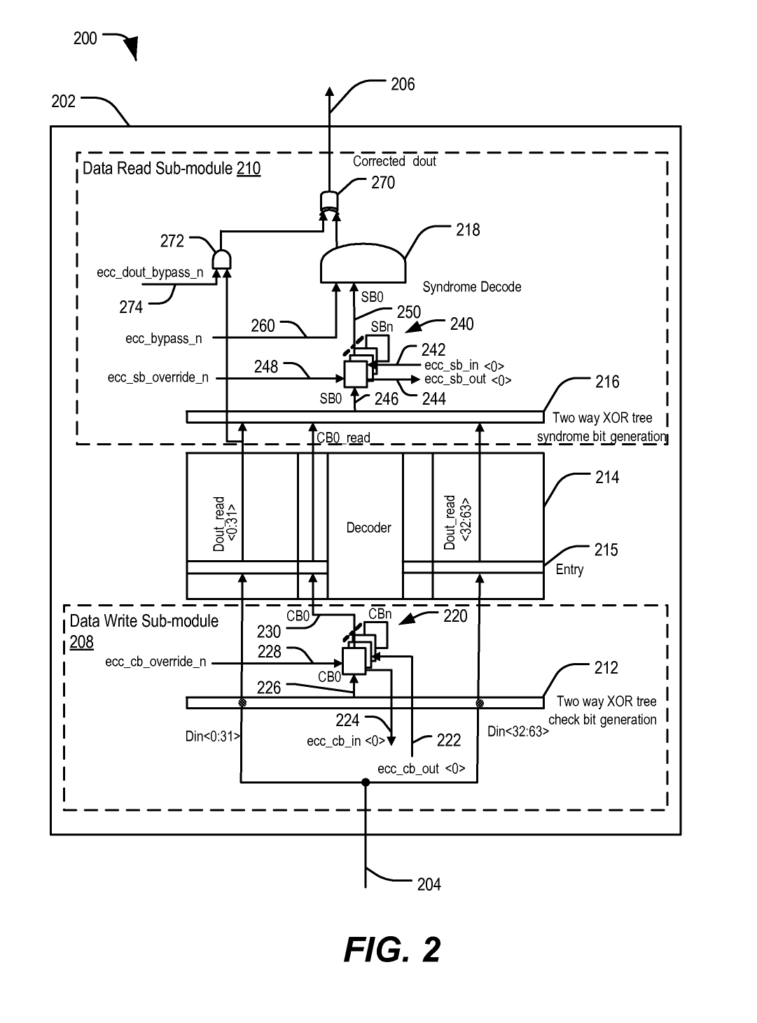

Referring to FIG. 2, a second illustrative embodiment of a system to test an error correction module is depicted and generally designated 200. The system 200 includes an error correction coding (ECC) module 202. The ECC module 202 has an input 204 and an output 206. The ECC module 202 includes a data write sub-module 208 and a data read sub-module 210. The data write sub-module 208 includes a check bit generation circuit 212 coupled to a first intermediate test port 220. The data read sub-module 210 includes a syndrome bit generation circuit 216 coupled to a second intermediate test port 240. The data read sub-module 210 also includes a syndrome decode circuit 218, a bypass logic circuit 272, and an output logic circuit 270. A data transport or storage system, such as a memory 214, is coupled to receive an output of the data write sub-module 208 and to provide an input to the data read sub-module 210.

The first intermediate test port 220 has a test input 222 and a test output 224. The test input 222 and the test output 224 enable access to observe and/or modify data stored at the first intermediate test port 220. In addition, the first intermediate test port 220 is configured to receive input data from the check bit generation circuit 212 via a data input 226 and to provide a data output 230 to the memory 214. In addition, the first intermediate test port 220 is configured to receive a control input 228 to control an operation of the first intermediate test port 220.

The second intermediate test port 240 has a test input 242 and a test output 244. The test input 242 and the test output 244 enable access to observe and/or modify data stored at the second intermediate test port 240. In addition, the second intermediate test port 240 is configured to receive input data from the syndrome bit generation circuit 216 via a data input 246 and to provide a data output 250 to the syndrome decode circuit 218. In addition, the second intermediate test port 240 is configured to receive a control input 248 to control an operation of the second intermediate test port 240.

During operation, data may be received at the input 204. In a particular embodiment, the data includes a 64-bit word to be stored at the memory 214, which may be external to the ECC module 202. The data is divided into two sub-words of 32-bits each. Each sub-word is processed by the check bit generation circuit 212 to generate one or more check bits (CB0 . . . CBn) based on a characteristic of the input data, such as a parity of one or more bits of the input data. In an illustrative embodiment, the check bit generation circuit 212 includes a two way XOR tree.

The check bits CB0 . . . CBn are provided via the data input 226 to the first intermediate test port 210, where one or more of the check bits may be observed and/or altered by an external user or system via the test input 222, the test output 224, and the control input 228. Thus, an operation of the check bit generation circuit 212 may be tested by providing data at the input 204 and observing the generated check bit data CB0 . . . CBn at the first intermediate test port 220.

The input data, including the first 32-bit word and the second 32-bit word, and the check bit data from the first intermediate test port 220 may be stored at the memory 214, such as at a representative entry 215. In a particular embodiment, the check bit data may be retrieved from the memory 214 and provided to the first intermediate test port 220, so that the check bit data may be inspected via the output 224. Thus, an operation of the memory 214 may be tested by providing check bit data at the first intermediate test port 220, storing the check bit data at the memory 214, retrieving the check bit data from the memory 214, and observing the retrieved check bit data at the first intermediate test port 220.

The data and check bit data associated with the entry 215 may be retrieved from the memory 214 at the data read sub-module 210 and processed by the syndrome bit generation circuit 216. In a particular embodiment, the syndrome bit generation circuit 216 is adapted to compare the retrieved data and the check bit data via one or more processing algorithms to identify an error in the received data. In a particular embodiment, the syndrome bit generation circuit 216 includes one or more two way XOR trees. In a particular embodiment, syndrome bit data including one or more syndrome bits SB0 . . . SBn associated with data retrieved from the memory 214 is provided to the input 246 of the second intermediate test port 240.

When the second intermediate test port 240 receives the syndrome bit data via the data input 246, the syndrome bits SB0 . . . SBn may be observed at the test output 244 and may be altered via the test input 242. Thus, an operation of the syndrome bit generation circuit 216 may be tested by storing test data at the memory 214, reading the test data from the memory 214 to the data read sub-module 210, and observing the generated syndrome bit data SB0 . . . SBn at the second intermediate test port 240. In addition, syndrome bits received at the data input 246 may be replaced with data received at the test input 242 from an external source, such as from a user testing the ECC module 202 by inserting a control signal at the control input 248.

The second intermediate test port 240 provides data to the syndrome decode circuit 218 via a data output 250. The syndrome decode circuit 218 determines a location of one or more errors in the data retrieved from the memory 214 based on values of the received syndrome bits, and provides an output to the output logic circuit 270. Alternatively, the syndrome decode circuit 218 may receive a bypass control signal via an ECC bypass input 260 to bypass at least a portion of the syndrome decode circuit 218. For example, the bypass control signal may cause the syndrome decode circuit to output an all-zero result, indicating that no errors are detected, even if the syndrome bits SB0 . . . SBn indicate one or more errors have been detected in the data read from the memory 214. As another example, the syndrome decode circuit 218 may provide data received via the ECC bypass input 260 to the output logic 270.

Data output by the syndrome decode circuit 218 is received at the output logic circuit 270. The output logic circuit 270 also receives data output by the ECC bypass circuit 272, which is responsive to the ECC data bypass input 274 to output either the data retrieved from the memory 214 or a bypass signal, such as an all-zero data output. The output logic circuit 270 may perform a bitwise XOR of the data received from the syndrome decoder circuit 218 and data received from the ECC bypass circuit 272 to provide corrected output data at the output 206.

The intermediate test ports 220 and 240 of the ECC module 202 enable observation and testing of data throughout the ECC module 202. The check bit generation circuit 212, the syndrome bit generation circuit 216, and the syndrome decode circuit 218 may each be independently tested. Any of the check bit generation circuit 212, the syndrome bit generator circuit 216, and the syndrome decode circuit 218 may also be bypassed for testing purposes or during normal operation. For example, a faulty syndrome bit generation circuit 216 may be bypassed by coupling an external syndrome bit generator (not shown) to receive data from the memory 214, generate syndrome bits, and inject the generated syndrome bits into the sub-module 210 at the second intermediate test port 240 using the test input 242 and the override input 248.

Although the system 200 depicts the data write sub-module 208 and the data read sub-module 210 as components of the ECC module 202, in other embodiments the data read sub-module 210 and the data write sub-module 208 may be components of separate ECC modules. Further, although the system 200 depicts the memory 214 coupled between the sub-modules 208 and 210, in other embodiments, other systems in which a data signal may be corrupted may be coupled between the sub-modules 208 and 210. Illustrative examples include a bus, a transmitter/communication channel/receiver path, a data storage device such as a latch or a register file, other devices or systems, or any combination thereof.

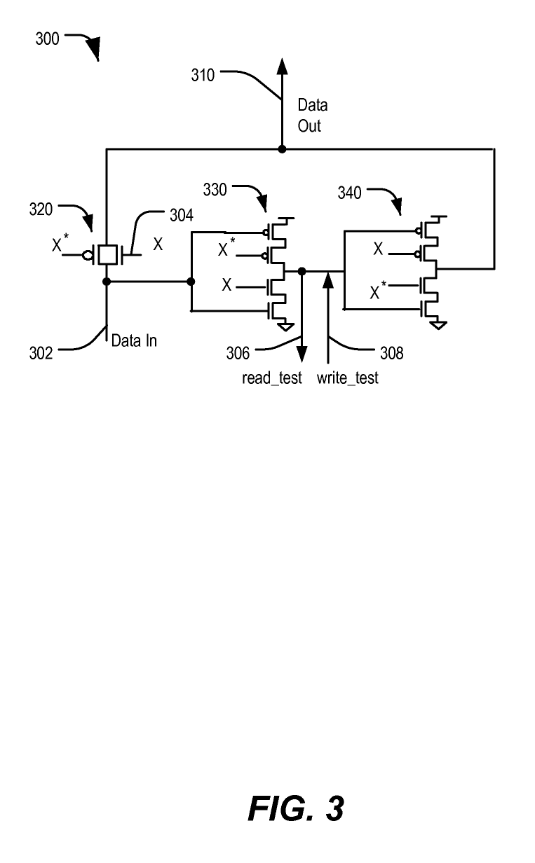

Referring to FIG. 3, a particular illustrative embodiment of a component of an intermediate test port is depicted and generally designated 300. The component 300 includes a data input 302, an override input 304, a read output 306, a write input 308, and a data output 310. A switch 320 is coupled between the data input 302 and the data output 310. A first buffer 330 is coupled to receive the data input 302 and to provide an output to the read output 306. A second buffer 340 is coupled to receive the write input 308 and has an output that is coupled to the data output 310. The switch 320, first buffer 330, and second buffer 340 are each responsive to an override signal (X) received via the override input 304 and to an inverted override signal (X*).

During operation, when the override signal X is “1”, data received at the data input 302 is provided to the data output 310 via the switch 320. The first buffer 330 inverts the data input and provides the inverted data input to the test output 306, and the second buffer 340 provides a high-impedance output. In this operating mode, data received at the data input 302 is provided to the data output 310 and is observable at the test output 306.

When the override signal X is “0”, the switch 320 prevents data received at the data input 302 from being directly provided to the data output 310. In addition, the first buffer 330 provides a high-impedance output. The second buffer 340 inverts data received at the test input 308 and provides the inverted data to the data output 310. In this operating mode, data received at the data input 302 is discarded, and data received at the test input 308 is provided to the data output 310.

In a particular embodiment, the component 300 is included in an intermediate test port and enables functions of the intermediate test port for a single bit of a multi-bit data value at the intermediate test port. For example, the first intermediate test port 220 illustrated in FIG. 2 is configured to receive N+1 check bits (CB0, CB1, . . . CBn) and may therefore include N+1 instances of the component 300, one instance for each of the N+1 check bits. The override input 304 may be coupled to the control signal 228, the read output 306 may be coupled to the test output 224, the write input 308 may be coupled to the test input 222, and the data output 310 may be coupled to the data output 230.

In another particular embodiment, the component 300 is included in the second intermediate test port 240 illustrated in FIG. 2. The override input 304 may be coupled to the control signal 248, the read output 306 may be coupled to the test output 244, the write input 308 may be coupled to the test input 242, and the data output 310 may be coupled to the data output 250.

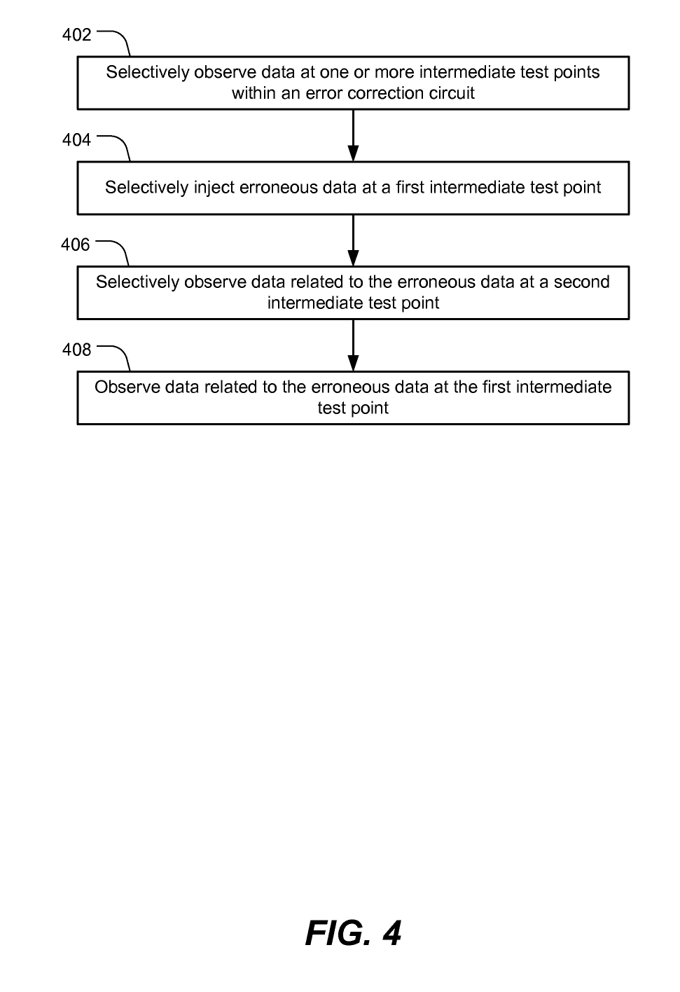

Referring to FIG. 4, a method of testing an error correction circuit device is depicted. The method includes selectively observing data at one or more intermediate test points within an error correction circuit, at 402. In a particular embodiment, the observed data has multiple bit errors. In an illustrative embodiment, the error correction circuit may include an error correction coding (ECC) module, such as the ECC module 102 or 202 illustrated in FIGS. 1-2.

The intermediate test point may include an exclusive-OR (XOR) tree, a decoder, a syndrome decoder, other elements of an error correction circuit, or any combination thereof. In a particular embodiment, the XOR tree may include a check bit tree or a syndrome tree.

Moving to 404, in a particular embodiment, erroneous data is selectively injected at a first intermediate test point. Continuing to 406, in a particular embodiment, data related to the erroneous data is selectively observed at a second intermediate test point. For example, a sub-module may be tested by injecting erroneous data at a first intermediate test point at an input to the sub-module and observing output data of the sub-module at a second intermediate test point.

Advancing to 408, in a particular embodiment, data related to the erroneous data is observed at the first intermediate test point. For example, when the first intermediate test point includes bidirectional buffers, such as the first intermediate test port 220 illustrated in FIG. 2, the erroneous data may be injected to the first intermediate test point and stored at a data storage or transport device, such as the memory 214. Data may be read out of the data storage or transport device to the first intermediate test point and observed for accuracy.

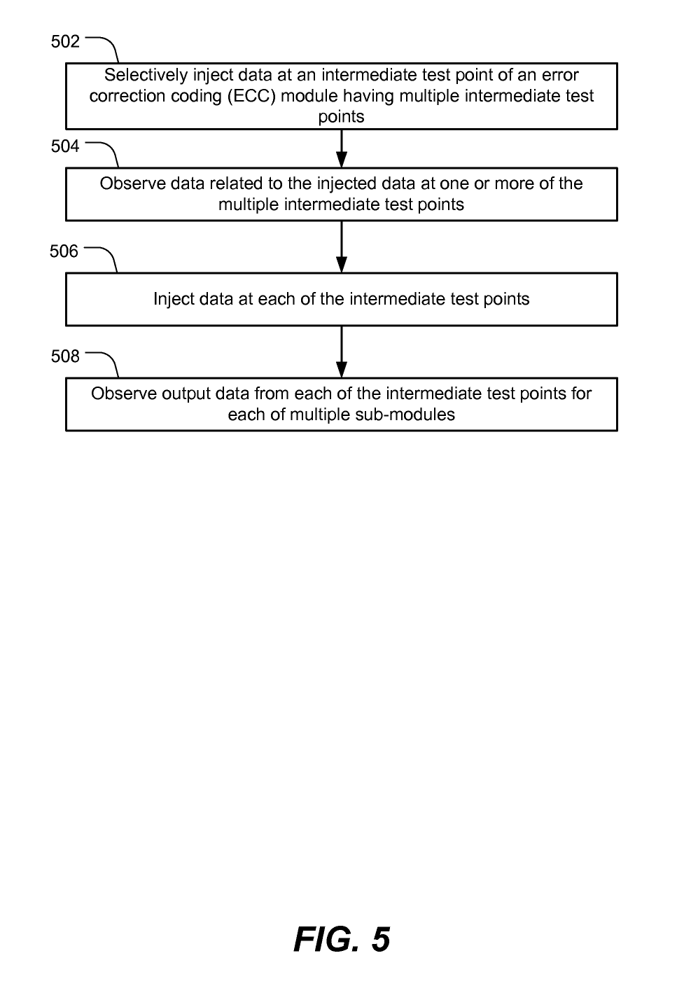

Referring to FIG. 5, a method of testing an error correction module is depicted. The method includes selectively injecting data at an intermediate test point of an error correction coding (ECC) module having multiple intermediate test points, at 502. Moving to 504, data related to the injected data is observed at one or more of the multiple intermediate test points.

In an illustrative embodiment, the ECC module may be the ECC module 102 or 202 illustrated in FIGS. 1-2. In a particular example, the intermediate test point includes a check bit tree override select input to selectively override a check bit tree associated with the ECC module. As another example, the intermediate test point may include a syndrome bit tree override to selectively override a syndrome bit tree associated with the ECC module. As another example, the intermediate test point may include an ECC bypass input to override the ECC module. In a particular embodiment, the intermediate test point may include a mode selection input to select a syndrome decoder testing mode.

In a particular embodiment, the ECC module includes multiple sub-modules. Each of the sub-modules may include an intermediate test point. Each of the sub-modules may also include a control to selectively enable or disable its associated intermediate test point.

Continuing to 506, in a particular embodiment, data is injected at each of the intermediate test points. Proceeding to 508, output data from each of the plurality of intermediate test points is observed for each of the sub-modules. In an illustrative embodiment, the data may be injected and observed by a scan test logic module, such as the scan test logic 132 illustrated in FIG. 1, which may systematically test the error correction circuit device for malfunctions.

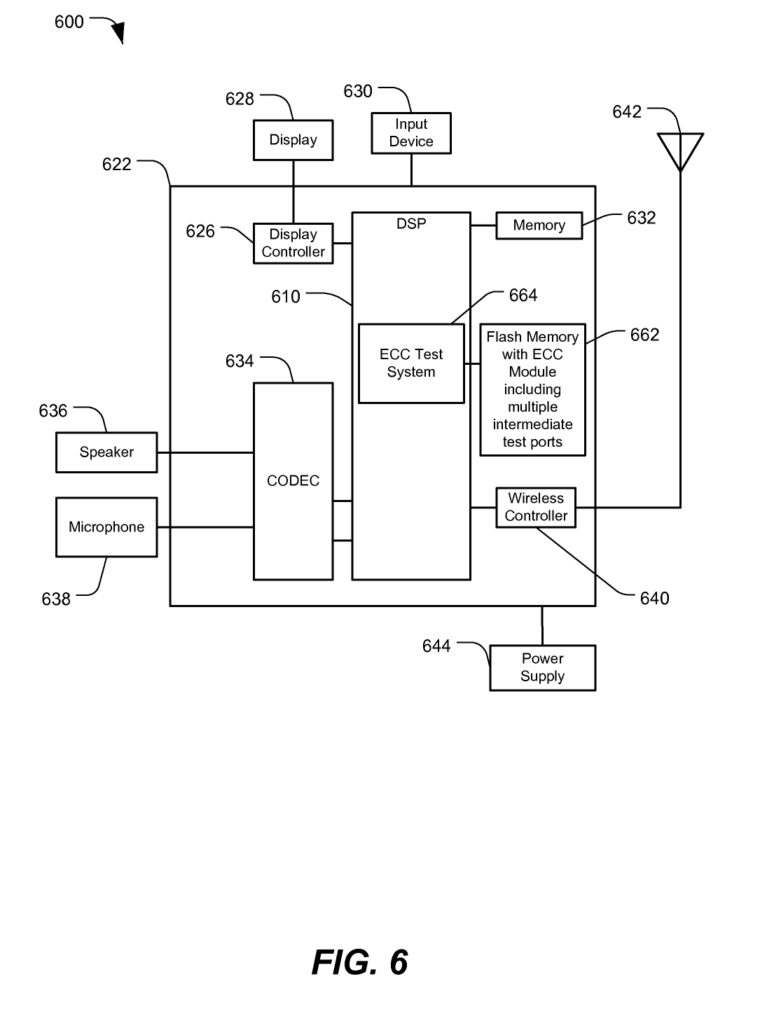

FIG. 6 is a block diagram of a communication device 600 that includes a system to test an error correction module. The communications device 600 includes a memory with an error correction module, such as a flash memory with an error correction coding (ECC) module including multiple intermediate test ports 662, that is coupled to a processor, such as a digital signal processor (DSP) 610. The DSP 610 includes a system to test the error correction module, such as an ECC test system 664. In a particular embodiment, the flash memory with an ECC module including multiple intermediate test ports is responsive to the ECC test system 664 and may operate as described with respect to FIGS. 1-5.

FIG. 6 also shows a display controller 626 that is coupled to the digital signal processor 610 and to a display 628. A memory 632 is coupled to the DSP 610. A coder/decoder (CODEC) 634 can also be coupled to the digital signal processor 610. A speaker 636 and a microphone 638 can be coupled to the CODEC 634.

FIG. 6 also indicates that a wireless controller 640 can be coupled to the digital signal processor 610 and to a wireless antenna 642. In a particular embodiment, an input device 630 and a power supply 644 are coupled to the on-chip system 622. Moreover, in a particular embodiment, as illustrated in FIG. 6, the display 628, the input device 630, the speaker 636, the microphone 638, the wireless antenna 642, and the power supply 644 are external to the on-chip system 622. However, each can be coupled to a component of the on-chip system 622, such as an interface or a controller.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in RAM memory, MRAM memory, flash memory, ROM memory, PROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined by the following claims.

What is claimed is:

1. A method of testing an error correction circuit device, the method comprising:
selectively observing data at one or more intermediate test points within an error correction circuit.

2. The method of claim 1, wherein the observed data comprises multiple bit errors.

3. The method of claim 1, wherein the intermediate test point comprises one or more of an exclusive OR tree, a decoder, and a syndrome decoder.

4. The method of claim 3, wherein the exclusive OR tree comprises a check bit tree or a syndrome tree.

5. The method of claim 1, further comprising:
selectively injecting erroneous data at a first intermediate test point; and
selectively observing data related to the erroneous data at a second intermediate test point.

6. The method of claim 5, further comprising observing data related to the erroneous data at the first intermediate test point.

7. A method of testing an error correction module, the method comprising:
selectively injecting data at an intermediate test point of an error correction coding (ECC) module having multiple intermediate test points; and
observing data related to the injected data at one or more of the multiple intermediate test points.

8. The method of claim 7, wherein the intermediate test point includes a check bit tree override select input to selectively override a check bit tree associated with the ECC module.

9. The method of claim 7, wherein the intermediate test point includes a syndrome bit tree override to selectively override a syndrome bit tree associated with the ECC module.

10. The method of claim 7, wherein the intermediate test point includes an ECC bypass input to override the ECC module.

11. The method of claim 7, wherein the intermediate test point includes a mode selection input to select a syndrome decoder testing mode.

12. The method of claim 7, wherein the ECC module includes a plurality of sub-modules where each of the plurality of sub-modules includes an intermediate test point and wherein each of the sub-modules includes a control to selectively enable or disable its associated intermediate test point.

13. The method of claim 12, further comprising injecting data at each of the intermediate test points and observing output data from each of the plurality of intermediate test points for each of the plurality of sub-modules.

14. A system comprising:
an error correction coding (ECC) module including an input to receive data and an output to provide error corrected data, the ECC module further comprising:
a plurality of intermediate test ports; and
ECC functionality testing logic coupled to the plurality of intermediate test ports.

15. The system of claim 14, wherein the ECC module includes a plurality of sub-modules, each of the plurality of sub-modules including at least one of the plurality of intermediate test ports.

16. The system of claim 15, wherein each of the plurality of sub-modules includes a control to selectively enable or disable the intermediate test port for such sub-module.

17. The system of claim 15, wherein each of the sub-modules includes an input to inject data to the intermediate test port.

18. The system of claim 17, wherein each of the sub-modules includes an output to provide observable data from the intermediate test port.

19. The system of claim 14, further comprising scan test logic coupled to each of the plurality of intermediate test ports to selectively apply scan tests at each of the plurality of intermediate test ports.

20. The system of claim 19, wherein a test of the ECC module is performed independently from use of the scan test logic.

21. The system of claim 14, further comprising a plurality of external pins to provide external access to the intermediate test ports.

22. The system of claim 14, further comprising:
a data write sub-module coupled to the input, the data write sub-module including a first intermediate test port; and
a data read sub-module coupled to the output, the data read sub-module including a second intermediate test port.

23. The system of claim 22, wherein the data write sub-module is responsive to a test output, a test input, and an override input.

24. The system of claim 22, wherein the data read sub-module is responsive to a test input, a test output, an override input, and an ECC bypass input.
